(19) United States
(12) Patent Application Publication
(10) Pub. No.: US 2019/0224902 A1
(43) Pub. Date: Jul. 25, 2019

(54) METHOD FOR PRODUCING A POLYMER FILM

(71) Applicant: BASF SE, Ludwigshafen am Rhein (DE)

(72) Inventors: Walter GOETZ, Gruenenbach (DE); Rolf MINKWITZ, Ludwigshafen (DE); Rolf-Egbert GRUETZNER, Ludwigshafen (DE); Florian RICHTER, Ludwigshafen (DE)

(73) Assignee: BASF SE, Ludwigshafen am Rhein (DE)

(21) Appl. No.: 16/333,105

(22) PCT Filed: Sep. 5, 2017
(86) PCT No.: PCT/EP2017/072224

§ 371 Date: Mar. 13, 2019

(30) Foreign Application Priority Data
Sep. 14, 2016 (EP) 16188742.7

(51) Int. Cl. B29C 48/00; C08G 69/34; C08G 69/36; B29C 48/10; B29C 55/28; B29C 48/88

(52) U.S. Cl. CPC B29C 48/022; C08G 69/34; C08G 69/36; B29K 2077/00; B29C 55/28; B29C 48/912; B29C 48/919; B29C 48/10

(57) ABSTRACT

The present invention relates to a process for producing a polymer film (P) comprising at least one copolyamide by extrusion of the copolyamide through a ring die and subsequent stretching of the tube thus obtained by blowing in air. The present invention further relates to the polymer film (P) obtainable by the process of the invention and to a process for packing foods.

The present invention relates to a process for producing a polymer film (P) comprising at least one copolyamide by extrusion of the copolyamide through a ring die and subsequent stretching of the tube thus obtained by blowing in air. The present invention further relates to the polymer film (P) obtainable by the process of the invention and to a process for packing foods.

Polyamides are of particular significance in industry since they feature very good mechanical properties and especially have high strength and toughness, good chemical stability and high abrasion resistance. They are used, for example, for production of fishing line, climbing rope and carpet backing. Furthermore, polyamides find use for production of packing films and packing sheaths.

An overview of the use as packing films and packing sheaths and processes for production thereof is described, for example, in Encyclopedia of Polymer Science and Engineering 2nd Ed., Vol. 7, pp. 73-127, Vol. 10, pp. 684-695 (John Wiley & Sons, Inc., 1987). However, the polyimide films described therein are very stiff and have low tear propagation resistance and high density.

For packing films and packing sheaths, therefore, copolyamides that combine positive properties of different polyamides are frequently used. The prior art describes various copolyamides.

EP 0 352 562 describes films composed of copolyamides, wherein the copolyamides have been prepared from ε-caprolactam and preferably 1 to 10 parts by weight of a dimer acid and a diamine. The copolyamides can then be used for production of flat or blown films. They are likewise suitable for production of composite films.

A disadvantage of the films of copolyamide described in EP 0 352 562 is that they have relatively low tear propagation resistance, a high modulus of elasticity and a low puncture energy.

DE 28 46 596 describes shaped bodies composed of a copolyamide of caprolactam, fatty acid dimers and hexamethylenediamine. However, the thermoplastics described cannot be extruded to a film.

A disadvantage of the polymer films as produced in processes from the prior art is that the polymer films frequently have high resilience and are frequently very stiff.

It is therefore an object of the present invention to provide a process for producing a polymer film (P) that has the disadvantages of the processes described in the prior art only to a very reduced degree, if at all. The process should additionally be performable in a very simple and inexpensive manner.

This object is achieved by a process for producing a polymer film (P) comprising the steps of
i) providing at least one copolyamide prepared by polymerizing the following components:
   (A) 15% to 84% by weight of at least one lactam,
   (B) 16% to 85% by weight of a monomer mixture (M) comprising the following components:
      (B1) at least one C₃₂-C₄₀ dimer acid and
      (B2) at least one C₄-C₁₂ diamine,
where the percentages by weight of components (A) and (B) are each based on the sum total of the percentages by weight of components (A) and (B), in molten form in a first extruder,
ii) extruding the at least one copolyamide provided in step i) in molten form from the first extruder through a ring die to obtain a tube comprising the at least one copolyamide in molten form,
iii) cooling the tube obtained in step ii) which comprises the at least one copolyamide in molten form in a water bath to a first temperature (T₁), solidifying the at least one copolyamide to obtain a first tubular film comprising the at least one copolyamide,
iv) heating the first tubular film obtained in step iii) to a second temperature (T₂) to obtain a heated first tubular film comprising the at least one copolyamide,
v) blowing air into the heated first tubular film obtained in step iv) to extend the width of the heated first tubular film, and cooling the heated first tubular film to a third temperature (T₃) to obtain the polymer film (P) comprising the at least one copolyamide.

A polymer film (P) produced by the process of the invention surprisingly has high tear propagation resistance both in extrusion direction and at right angles thereto. This is especially advantageous when the polymer film (P) produced in accordance with the invention is being used in a process for packing foods.

The polymer film (P) produced by the process of the invention additionally has lower resilience to DIN 53369 and also features good shrink properties.

Furthermore, the polymer film (P) produced in accordance with the invention has high transparency and high low-temperature toughness. It is additionally advantageous that the polymer film (P) produced by the process of the invention is less stiff than the polymer films produced by processes described in the prior art. The polymer film (P) produced in accordance with the invention also has a low modulus of elasticity and high puncture resistance in the dry state. High puncture resistance is likewise especially important when the polymer film (P) is being used for packing foods.

The process of the invention is elucidated in detail hereinafter.

Step i)

In step i), at least one copolyamide in molten form is provided in an extruder. The at least one copolyamide is prepared by polymerizing components (A), 15% to 84% by weight of at least one lactam, and (B) 16% to 85% by weight of a monomer mixture (M), where the percentages by weight of components (A) and (B) are each based on the sum total of the percentages by weight of components (A) and (B). The monomer mixture (M) comprises components (B1), at least one C₃₂-C₄₀ dimer acid, and (B2), at least one C₄-C₁₂ diamine.

In the context of the present invention, “at least one copolyamide” means either exactly one copolyamide or a mixture of two or more copolyamides.

In the context of the present invention, “a first extruder” means either exactly one first extruder or two or more first extruders. Typically, in the process of the invention, as many first extruders are used as the number of first layers comprising the at least one copolyamide that are to be present in the polymer film (P) to be produced.

If the polymer film (P) produced in the process of the invention is to comprise exactly one first layer comprising the at least one copolyamide, for example, exactly one first extruder is used. If the polymer film (P) is to comprise exactly two first layers comprising the at least one copolyamide, exactly two first extruders are used. If the polymer film (P) is to comprise exactly five first layers comprising the at least one copolyamide, exactly five first extruders are used.

For example, the at least one copolyamide is provided in one to eleven first extruders, preferably in one to five first extruders and more preferably in one to three first extruders.

According to the invention, the at least one copolyamide is provided in molten form.

In the context of the present invention, “in molten form” means that the at least one copolyamide is provided at a temperature (T_{C}) above the melting temperature (T_{M(C)}) of the at least one copolyamide. “In molten form” thus means that the at least one copolyamide is at a temperature (T_{C}) above the melting temperature (T_{M(C)}) of the at least one copolyamide. If the at least one copolyamide is in molten form, the at least one copolyamide is free-flowing.

“Free-flowing” means that the at least one copolyamide can be conveyed in the first extruder and that the at least one copolyamide can be extruded from the first extruder.

For example, the at least one copolyamide is provided in step i) at a temperature (T_{C}) in the range from 170 to 300° C., preferably in the range from 200 to 290° C. and especially preferably in the range from 230 to 280° C., in each case assuming that the temperature (T_{C}) at which the at least one copolyamide is provided is above the melting temperature (T_{M(C)}) of the at least one copolyamide.

The at least one copolyamide can be provided in molten form in the first extruder by any methods known to those skilled in the art.

For example, the at least one copolyamide can be supplied to the first extruder in molten or solid form. If the at least one copolyamide is supplied to the first extruder in solid form, it can be supplied to the first extruder, for example, in the form of pellets and/or of powder. The at least one copolyamide is then melted in the first extruder and thus provided in molten form in the first extruder. This embodiment is preferred.

In addition, it is possible that components (A) and (B) are polymerized directly in the first extruder and hence the at least one copolyamide is provided in molten form in the extruder. Processes for this purpose are known to those skilled in the art.

It is additionally possible that, in step i), additives are provided in the first extruder together with the at least one copolyamide in molten form. The additives are typically compounded (mixed) with the at least one copolyamide in molten form in the first extruder. Processes for this purpose are known to those skilled in the art.

Suitable additives are known to those skilled in the art and are selected, for example, from the group consisting of stabilizers, dyes, antistats, tackifiers, antiblocking agents, processing aids, antioxidants, light stabilizers, UV absorbers, lubricants and nucleating aids.

Suitable dyes are organic and inorganic pigments, for example sized titanium dioxide. Suitable tackifiers are, for example, polyisobutylene (PIB) or ethylene-vinyl acetate (EVA). Suitable antiblocking agents are, for example, silicon dioxide or calcium carbonate particles. Suitable light stabilizers are, for example, what are called HALS (hindered amine light stabilizers). Processing aids or lubricants used may, for example, be ethylenebisstearamide (EBS) wax. Nucleating aids may, for example, be all kinds of organic or inorganic crystallization nucleators, for example talc.

There follows a detailed description of the at least one copolyamide.

Copolyamide

According to the invention, the at least one copolyamide is prepared by polymerizing the following components:
(A) 15% to 84% by weight of at least one lactam,
(B) 16% to 85% by weight of a monomer mixture (M) comprising the following components:
   (B1) at least one C₃₂-C₄₀ dimer acid and
   (B2) at least one C₄-C₁₂ diamine, where the percentages by weight of components (A) and (B) are each based on the sum total of the percentages by weight of components (A) and (B).

In the context of the present invention the terms “component (A)” and “at least one lactam” are used synonymously and therefore have the same meaning.

The same applies to the terms “component (B)” and “monomer mixture (M)”. These terms are likewise used synonymously in the context of the present invention and therefore have the same meaning.

According to the invention, the at least one copolyamide is prepared by polymerizing 15% to 84% by weight of component (A) and 16% to 85% by weight of component (B), preference being given to preparing the at least one copolyamide by polymerizing 40% to 83% by weight of component (A) and 17% to 60% by weight of component (B), and the at least one copolyamide especially preferably being prepared by polymerizing 60% to 80% by weight of component (A) and 20% to 40% by weight of component (B), where the percentages by weight of components (A) and (B) are each based on the sum total of the percentages by weight of components (A) and (B).

Preferably, the sum total of the percentages by weight of components (A) and (B) is 100% by weight.

It will be apparent that the percentages by weight of components (A) and (B) are based on the percentages by weight of components (A) and (B) prior to the polymerization, i.e. when components (A) and (B) have not yet reacted with one another. During the polymerization of components (A) and (B), the weight ratio of components (A) and (B) may change.

According to the invention, the at least one copolyamide is prepared by polymerizing components (A) and (B). The polymerization of components (A) and (B) is known to those skilled in the art. Typically, the polymerization of components (A) and (B) is a condensation reaction. During the condensation reaction, component (A) reacts with components (B1) and (B2) present in component (B) and if appropriate with component (B3) which is described further down and may likewise be present in component (B). This forms amide bonds between the individual components. Typically, component (A) is at least partly in open-chain form, i.e. as the amino acid, during the polymerization.

The polymerization of components (A) and (B) can take place in the presence of a catalyst. Suitable catalysts are all catalysts known to those skilled in the art that catalyze the polymerization of components (A) and (B). Catalysts of this kind are known to those skilled in the art. Preferred catalysts are phosphorus compounds, for example sodium hypophosphite, phosphorous acid, triphenylphosphine or triphenyl phosphite.

The polymerization of components (A) and (B) forms the at least one copolyamide, which therefore comprises structural units derived from component (A) and structural units derived from component (B). Structural units derived from component (B) comprise structural units derived from components (B1) and (B2) and, if appropriate, from component (B3).

The polymerization of components (A) and (B) forms the copolyamide as a copolymer. The copolymer may be a random copolymer. It is likewise possible that it is a block copolymer.

In a block copolymer there is formation of blocks of units derived from component (B), and blocks of units derived from component (A). These alternate. In a random copolymer, there is alternation of structural units derived from component (A) with structural units derived from component (B). This alternation is statistical. For example, two structural units derived from component (B) may be followed by one structural unit derived from component (A), which is followed in turn by one structural unit derived from component (B), which is then followed by a structural unit comprising three structural units derived from component (A).

Preferably, the at least one copolyamide is a random copolymer.

The present invention therefore also provides a process in which the at least one copolyamide is a random copolymer.

The preparation of the at least one copolyamide preferably comprises the following steps:
I) polymerizing components (A) and (B) to obtain at least one first copolyamide,
II) pelletizing the at least one first copolyamide obtained in step I) to obtain at least one pelletized copolyamide,
III) extracting the at least one pelletized copolyamide obtained in step II) with water to obtain at least one extracted copolyamide,
IV) drying the at least one extracted copolyamide obtained in step III) at a temperature (T_{T}) to obtain the at least one copolyamide.

The present invention therefore also provides a process in which the at least one copolyamide is prepared in a process comprising the following steps:
I) polymerizing components (A) and (B) to obtain at least one first copolyamide,
II) pelletizing the at least one first copolyamide obtained in step I) to obtain at least one pelletized copolyamide,
III) extracting the at least one pelletized copolyamide obtained in step II) with water to obtain at least one extracted copolyamide,
IV) drying the at least one extracted copolyamide obtained in step III) at a temperature (T_{T}) to obtain the at least one copolyamide.

The polymerization in step I) can take place in any reactors known to those skilled in the art. Preference is given to stirred tank reactors. It is additionally possible to use auxiliaries known to those skilled in the art to improve the reaction regime, for example defoamers such as polydimethylsiloxane (PDMS).

In step II), the at least one first copolyamide obtained in step I) can be pelletized by any methods known to those skilled in the art, for example by means of strand pelletization or underwater pelletization.

The extraction in step III) can be effected by any methods known to those skilled in the art.

During the extraction in step III), by-products formed in step I) during the polymerization of components (A) and (B) are typically extracted from the at least one pelletized copolyamide.

In step IV), the at least one extracted copolyamide obtained in step III) is dried. Processes for drying are known to those skilled in the art. According to the invention, the at least one extracted copolyamide is dried at a temperature (T_{T}). The temperature (T_{T}) is preferably above the glass transition temperature (T_{G(C)}) of the at least one copolyamide and below the melting temperature (T_{M(C)}) of the at least one copolyamide.

The drying in step IV) is typically effected for a period of time in the range from 1 to 100 hours, preferably in the range from 2 to 50 hours and especially preferably in the range from 3 to 40 hours.

It is thought that the drying in step IV) further increases the molecular weight of the at least one copolyamide.

The at least one copolyamide typically has a glass transition temperature (T_{G(C)}). The glass transition temperature (T_{G(C)}) is, for example, in the range from 20 to 50° C., preferably in the range from 23 to 47° C. and especially preferably in the range from 25 to 45° C., determined to ISO 11357-2:2014.

The present invention therefore also provides a process in which the at least one copolyamide has a glass transition temperature (T_{G(C)}), where the glass transition temperature (T_{G(C)}) is in the range from 20 to 50° C.

The glass transition temperature (T_{G(C)}) of the at least one copolyamide is based, in accordance with ISO 11357-2:2014, in the context of the present invention, on the glass transition temperature (T_{G(C)}) of the dry copolyamide.

In the context of the present invention “dry” means that the at least one copolyamide comprises less than 1% by weight, preferably less than 0.5% by weight and especially preferably less than 0.1% by weight of water, based on the total weight of the at least one copolyamide. More preferably, “dry” means that the at least one copolyamide does not comprise any water, and most preferably that the at least one copolyamide does not comprise any solvent.

In addition, the at least one copolyamide typically has a melting temperature (T_{M(C)}). The melting temperature (T_{M(C)}) of the at least one copolyamide is, for example, in the range from 150 to 210° C., preferably in the range from 160 to 205° C. and especially preferably in the range from 160 to 200° C., determined to ISO 11357-3:2014.

The present invention therefore also provides a process in which the at least one copolyamide has a melting temperature (T_{M(C)}), where the melting temperature (T_{M(C)}) is in the range from 150 to 210° C.

The at least one copolyamide generally has a viscosity number (VN_{(C)}) in the range from 150 to 300 mL/g, determined in a 0.5% by weight solution of the at least one copolyamide in a mixture of phenol/o-dichlorobenzene in a weight ratio of 1:1.

Preferably, the viscosity number (VN_{(C)}) of the at least one copolyamide is in the range from 160 to 290 mL/g and more preferably in the range from 170 to 280 mL/g, determined in a 0.5% by weight solution of the at least one copolyamide in a mixture of phenol/o-dichlorobenzene in a weight ratio of 1:1.

The present invention therefore also provides a process in which the at least one copolyamide has a viscosity number (VN_{(C)}) in the range from 150 to 300 mL/g, determined in a 0.5% by weight solution of the at least one copolyamide in a mixture of phenol/o-dichlorobenzene in a ratio of 1:1.

Component (A)

Component (A) in the invention is at least one lactam.

In the context of the present invention, “at least one lactam” means either precisely one lactam or a mixture of two or more lactams.

Lactams are known as such to those skilled in the art. Preference is given in accordance with the invention to lactams having 4 to 12 carbon atoms.

In the context of the present invention, “lactams” are understood to mean cyclic amides having preferably 4 to 12 carbon atoms, more preferably 5 to 8 carbon atoms, in the ring.

Suitable lactams are for example selected from the group consisting of 3-aminopropanolactam (propio-3-lactam; β-lactam; β-propiolactam), 4-aminobutanolactam (butyro-4-lactam; γ-lactam; γ-butyrolactam), aminopentanolactam (2-piperidinone; δ-lactam; δ-valerolactam), 6-aminohexanolactam (hexano-6-lactam; ε-lactam; ε-caprolactam), 7-aminoheptanolactam (heptano-7-lactam; ζ-lactam; ζ-heptanolactam), 8-aminooctanolactam (octano-8-lactam; η-lactam; n-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam).

The present invention therefore also provides a process in which component (A) is selected from the group consisting of 3-aminopropanolactam, 4-aminobutanolactam, 5-aminopentanolactam, 6-aminohexanolactam, 7-aminoheptanolactam, 8-aminooctanolactam, 9-aminononanolactam, 10-aminodecanolactam, 11-aminoundecanolactam and 12-aminododecanolactam.

The lactams may be unsubstituted or at least monosubstituted. If at least monosubstituted lactams are used, the nitrogen atom and/or the ring carbon atoms thereof may bear one, two, or more substituents selected independently of one another from the group consisting of C₁- to C₁₀-alkyl, C₅- to C₆-cycloalkyl, and C₅- to C₁₀-aryl.

Suitable C₁- to C₁₀-alkyl substituents are, for example, methyl, ethyl, propyl, isopropyl, n-butyl, sec-butyl, and tert-butyl. A suitable C₅- to C₆-cycloalkyl substituent is for example cyclohexyl. Preferred C₅- to C₁₀-aryl substituents are phenyl or anthranyl.

It is preferable to employ unsubstituted lactams, γ-lactam (γ-butyrolactam), δ-lactam (δ-valerolactam) and ε-lactam (ε-caprolactam) being preferred. Particular preference is given to δ-lactam (5-valerolactam) and ε-Iactam (ε-caprolactam), ε-caprolactam being especially preferred.

Monomer mixture (M)

According to the invention, component (B) is a monomer mixture (M). The monomer mixture (M) comprises components (B1), at least one C₃₂-C₄₀ dimer acid, and (B2), at least one C₄-C₁₂ diamine.

In the context of the present invention, a monomer mixture (M) is understood to mean a mixture of two or more monomers, where at least components (B1) and (B2) are present in the monomer mixture (M).

In the context of the present invention, the terms “component (B1)” and “at least one C₃₂-C₄₀ dimer acid” are used synonymously and therefore have the same meaning. The same applies to the terms “component (B2)” and “at least one C₄-C₁₂ diamine”. These terms are likewise used synonymously in the context of the present invention and therefore have the same meaning.

The monomer mixture (M) comprises, for example, in the range from 45 to 55 mol % of component (B1) and in the range from 45 to 55 mol % of component (B2), based in each case on the sum total of the molar percentages of components (B1) and (B2), preferably based on the total molar amount of the monomer mixture (M).

Preferably, component (B) comprises in the range from 47 to 53 mol % of component (B1) and in the range from 47 to 53 mol % of component (B2), based in each case on the sum total of the molar percentages of components (B1) and (B2), preferably based on the total molar amount of component (B).

More preferably, component (B) comprises in the range from 49 to 51 mol % of component (B1) and in the range from 49 to 51 mol % of component (B2), based in each case on the sum total of the molar percentages of components (B1) and (B2), preferably based on the total molar amount of component (B).

The present invention therefore also provides a process in which component (B) comprises in the range from 45 to 55 mol % of component (B1) and in the range from 45 to 55 mol % of component (B2), based in each case on the total molar amount of component (B).

The sum total of the molar percentages of components (B1) and (B2) present in component (B) typically adds up to 100 mol %.

Component (B) may additionally comprise a component (B3), at least one C₄-C₂₀ diacid.

The present invention therefore also provides a process in which component (B) additionally comprises a component (B3), at least one C₄-C₂₀ diacid.

In the context of the present invention, the terms “component (B3)” and “at least one C₄-C₂₀ diacid” are used synonymously and therefore have the same meaning.

When component (B) additionally comprises component (B3), it is preferable that component (B) comprises in the range from 25 to 54.9 mol % of component (B1), in the range from 45 to 55 mol % of component (B2) and in the range from 0.1 to 25 mol % of component (B3), based in each case on the total molar amount of component (B).

More preferably, component (B) in that case comprises in the range from 13 to 52.9 mol % of component (B1), in the range from 47 to 53 mol % of component (B2) and in the range from 0.1 to 13 mol % of component (B3), based in each case on the total molar amount of component (B).

Most preferably, component (B) in that case comprises in the range from 7 to 50.9 mol % of component (B1), in the range from 49 to 51 mol % of component (B2) and in the range from 0.1 to 7 mol % of component (B3), based in each case on the total molar amount of component (B).

When component (B) additionally comprises component (B3), the molar percentages of components (B1), (B2) and (B3) typically add up to 100 mol %.

The monomer mixture (M) may further comprise water.

Components (B1) and (B2) and optionally (B3) of component (B) can react with one another to obtain amides. This reaction is known per se to those skilled in the art. Therefore, component (B) may comprise components (B1), (B2) and optionally (B3) in fully reacted form, in partly reacted form or in unreacted form. Preferably, component (B) comprises components (B1), (B2) and optionally (B3) in unreacted form.

In the context of the present invention, “in unreacted form” thus means that component (B1) is present as the at least one C₃₂-C₄₀ dimer acid and component (B2) as the at least one C₄-C₁₂ diamine, and any component (B3) as the at least one C₄-C₂₀ diacid.

If components (B1) and (B2) and any (B3) have at least partly reacted, components (B1) and (B2) and any (B3) are at least partly in amide form.

Component (B1)

According to the invention, component (B1) is at least one C₃₂-C₄₀ dimer acid.

In the context of the present invention, “at least one C₃₂-C₄₀ dimer acid” means either exactly one C₃₂-C₄₀ dimer acid or a mixture of two or more C₃₂-C₄₀ dimer acids.

Dimer acids are also referred to as dimer fatty acids. C₃₂-C₄₀ dimer acids are known as such to the person skilled in the art and are typically prepared by dimerizing unsaturated fatty acids.

This dimerization can be catalyzed, for example, by aluminas.

Suitable unsaturated fatty acids for preparation of the at least one C₃₂-C₄₀ dimer acid are known to those skilled in the art and are, for example, unsaturated C₁₆ fatty acids, unsaturated C₁₈ fatty acids and unsaturated C₂₀ fatty acids.

Preferably, component (B1) is therefore prepared proceeding from unsaturated fatty acids selected from the group consisting of unsaturated C₁₆ fatty acids, unsaturated C₁₈ fatty acids and unsaturated C₂₀ fatty acids, particular preference being given to the unsaturated C₁₃ fatty acids.

The present invention therefore also provides a process in which component (B1) is prepared proceeding from unsaturated fatty acids selected from the group consisting of unsaturated C₁₆ fatty acids, unsaturated C₁₈ fatty acids and unsaturated C₂₀ fatty acids.

An example of a suitable unsaturated C₁₆ fatty acid is palmitoleic acid ((9Z)-hexadeca-9-enoic acid).

Examples of suitable unsaturated C₁₈ fatty acids are selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid), a-linolenic acid ((9Z,12Z,15Z)-octadeca-9,12,15-trienoic acid), y-linolenic acid ((6Z,9Z,12Z)-octadeca-6,9,12-trienoic acid), calendulic acid ((8E,10E,12Z)-octadeca-8,10,12-trienoic acid), punicic acid ((9Z,11E,13Z)-octadeca-9,11,13-trienoic acid), a-eleostearic acid ((9Z,11E,13E)-octadeca-9,11,13-trienoic acid) and β-eleostearic acid ((9E,11E,13E)-octadeca-9,11,13-trienoic acid). Particular preference is given to unsaturated C₁₈ fatty acids selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid).

Examples of suitable unsaturated C₂₀ fatty acids are selected from the group consisting of gadoleic acid ((9Z)-eicosa-9-enoic acid), eicosenoic acid ((11Z)-eicosa-11-enoic acid), arachidonic acid ((5Z,8Z,11Z,14Z)-eicosa-5,8,11,14-tetraenoic acid) and timnodonic acid ((5Z,8Z,11Z,14Z,17Z)-eicosa-5,8,11,14,17-pentaenoic acid).

Component (B1) is especially preferably at least one C₃₆ dimer acid.

The at least one C₃₆ dimer acid is preferably prepared proceeding from unsaturated C₁₈ fatty acids. The C₃₆ dimer acid is more preferably prepared proceeding from C₁₈ fatty acids selected from the group consisting of petroselic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid) and linoleic acid ((9Z,12Z)-octadeca-9,12-dienoic acid).

The preparation of component (B1) from unsaturated fatty acids can additionally form trimer acids; residues of unreacted unsaturated fatty acid may also remain.

The formation of trimer acids is known to those skilled in the art.

Preferably in accordance with the invention, component (B1) comprises at most 0.5% by weight of unreacted unsaturated fatty acid and at most 0.5% by weight of trimer acid, more preferably at most 0.2% by weight of unreacted unsaturated fatty acid and at most 0.2% by weight of trimer acid, based in each case on the total weight of component (B1).

Dimer acids (also known as dimerized fatty acids or dimer fatty acids) thus refer generally, and especially in the context of the present invention, to mixtures that are prepared by oligomerization of unsaturated fatty acids. They are preparable, for example, by catalytic dimerization of unsaturated plant fatty acids, the starting materials used more particularly being unsaturated C₁₆ to C₂₀ fatty acids. The bonds are formed principally by the Diels-Alder mechanism, and the result, depending on the number and position of the double bonds in the fatty acids used to prepare the dimer acids, is mixtures of principally dimeric products having cycloaliphatic, linear aliphatic, branched aliphatic, and also C₆ aromatic hydrocarbon groups between the carboxyl groups. Depending on mechanism and/or any subsequent hydrogenation, the aliphatic radicals may be saturated or unsaturated, and the fraction of aromatic groups may also vary. The radicals between the carboxylic acid groups then contain, for example, 32 to 40 carbon atoms. For the preparation, fatty acids having 18 carbon atoms are used with preference, and so the dimeric product has 36 carbon atoms. The radicals which join the carboxyl groups of the dimer fatty acids preferably have no unsaturated bonds and no aromatic hydrocarbon radicals.

In the context of the present invention, C₁₈ fatty acids are thus used with preference in the preparation. Particular preference is given to the use of linolenic, linoleic and/or oleic acid.

Depending on the reaction regime, the above-identified oligomerization gives rise to mixtures comprising primarily dimeric molecules, but also trimeric molecules and monomeric molecules and other by-products. Purification is typically effected by distillation. Commercial dimer acids generally comprise at least 80% by weight of dimeric molecules, up to 19% by weight of trimeric molecules, and not more than 1% by weight of monomeric molecules and of other by-products.

It is preferable to use dimer acids that consist to an extent of at least 90% by weight, preferably to an extent of at least 95% by weight, most preferably to an extent of at least 98% by weight, of dimeric fatty acid molecules.

The proportions of monomeric, dimeric, and trimeric molecules and of other by-products in the dimer acids can be determined, for example, by means of gas chromatography (GC). In that case, prior to the GC analysis, the dimer acids are converted to the corresponding methyl esters via the boron trifluoride method (cf. DIN EN ISO 5509) and then analyzed by means of GC.

A fundamental identifier of “dimer acids” in the context of the present invention, therefore, is that their preparation involves the oligomerization of unsaturated fatty acids. This oligomerization gives rise principally, in other words preferably to an extent of at least 80% by weight, more preferably to an extent of at least 90% by weight, even more preferably to an extent of at least 95% by weight and more particularly to an extent of at least 98% by weight, to dimeric products. The fact that the oligomerization thus gives rise to predominantly dimeric products containing exactly two fatty acid molecules justifies this designation, which is commonplace in any case. An alternative expression for the relevant term “dimer acids”, therefore, is “mixture comprising dimerized fatty acids”.

The dimer acids to be used can be obtained as commercial products. Examples include Radiacid 0970, Radiacid 0971, Radiacid 0972, Radiacid 0975, Radiacid 0976, and Radiacid 0977 from Oleon, Pripol 1006, Pripol 1009, Pripol 1012, and Pripol 1013 from Croda, Empol 1008, Empol 1012, Empol 1061, and Empol 1062 from BASF SE, and Unidyme 10 and Unidyme TI from Arizona Chemical.

Component (B1) has, for example, an acid number in the range from 190 to 200 mg KOH/g.

Component (B2)

According to the invention, component (B2) is at least one C₄-C₁₂ diamine.

In the context of the present invention, “at least one C₄-C₁₂ diamine” means either exactly one C₄-C₁₂ diamine or a mixture of two or more C₄-C₁₂ diamines.

In the context of the present compound, “C₄-C₁₂ diamine” is understood to mean aliphatic and/or aromatic compounds having four to twelve carbon atoms and two amino groups (—NH₂ groups). The aliphatic and/or aromatic compounds may be unsubstituted or additionally at least mono-substituted. If the aliphatic and/or aromatic compounds are additionally at least monosubstituted, they may bear one, two or more substituents that do not take part in the polymerization of components (A) and (B). Substituents of this kind are, for example, alkyl or cycloalkyl substituents. These are known as such to those skilled in the art. Preferably, the at least one C₄-C₁₂ diamine is unsubstituted.

Examples of suitable components (B2) are selected from the group consisting of 1,4-diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane, 1,8-diaminooctane, 1,9-diaminononane, 1,10-diaminodecane (decamethylenediamine), 1,11-diaminoundecane (undecamethylenediamine) and 1,12-diaminododecane (dodecamethylenediamine).

Preferably, component (B2) is selected from the group consisting of tetramethylenediamine, pentamethylenediamine, hexamethylenediamine, decamethylenediamine and dodecamethylenediamine.

The present invention therefore also provides a process in which component (B2) is selected from the group consisting of tetramethylenediamine, pentamethylenediamine, hexamethylenediamine, decamethylenediamine and dodecamethylenediamine.

Component (B3)

According to the invention, any component (B3) present in component (B) is at least one C₄-C₂₀ diacid.

In the context of the present invention, “at least one C₄-C₂₀ diacid” means either exactly one C₄-C₂₀ diacid or a mixture of two or more C₄-C₂₀ diacids.

In the context of the present invention, “C₄-C₂₀ diacid” is understood to mean aliphatic and/or aromatic compounds having two to eighteen carbon atoms and two carboxyl groups (—COOH groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of components (A) and (B). Substituents of this kind are, for example, alkyl or cycloalkyl substituents. These are known to the person skilled in the art. Preferably, the at least one C₄-C₂₀ diacid is unsubstituted.

Examples of suitable components (B3) are selected from the group consisting of butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid, tetradecanedioic acid and hexadecanedioic acid.

Preferably, component (B3) is selected from the group consisting of pentanedioic acid (glutaric acid), hexanedioic acid (adipic acid), decanedioic acid (sebacic acid) and dodecanedioic acid.

Step ii)

In step ii), the at least one copolyamide provided in step i) is extruded in molten form from the first extruder through a ring die to obtain a tube comprising the at least one copolyamide in molten form.

In the context of the present invention, a “ring die” means either exactly one ring die or two or more ring dies. Preference is given in accordance with the invention to exactly one ring die.

Suitable ring dies are all ring dies known to those skilled in the art that enable extrusion of a tube from the at least one copolyamide in molten form. Suitable ring dies are known as such to those skilled in the art.

If, in a preferred embodiment of the present invention, step i1) described further down is conducted, it is preferable that, in step ii), the at least one copolyamide in molten form from the first extruder is combined with the at least one further polymer (FP) described further down in molten form from the further extruder in the ring die.

Especially preferably, in step ii), the at least one copolyamide in molten form from the first extruder is combined in the die with the at least one further polymer (FP) in molten form from the further extruder in such a way that the tube obtained in step ii), comprising the at least one copolyamide in molten form, comprises at least one first layer comprising the at least one copolyamide in molten form, and comprises at least one further layer comprising the at least one further polymer (FP) in molten form.

For example, the thickness of the tube comprising the at least one copolyamide in molten form is in the range from 10 to 1 mm, preferably in the range from 20 to 700 μm and especially preferably in the range from 50 to 500 μm.

The present invention therefore also provides a process in which the tube obtained in step ii) has a thickness in the range from 10 μm to 1 mm.

Step iii)

In step iii), the tube obtained in step ii) which comprises the at least one copolyamide in molten form is cooled in a water bath to a first temperature (T₁), solidifying the at least one copolyamide to obtain a first tubular film comprising the at least one copolyamide.

The first temperature (T₁) to which the tube is cooled is, for example, below the melting temperature (T_{M(C)}) of the at least one copolyamide; the temperature (T₁) is preferably below the glass transition temperature (T_{G(C)}) of the at least one copolyamide.

For example, the first temperature (T₁) in step iii) is in the range from 5 to 50° C., preferably in the range from 10 to 45° C. and especially preferably in the range from 15 to 40° C.

The present invention therefore also provides a process in which the first temperature (T₁) in step iii) is in the range from 5 to 50° C.

The water bath comprises water. The water bath may additionally comprise further components, for example alcohols.

Preferably in accordance with the invention, the water bath consists of water.

The temperature of the water bath in step iii) is, for example, in the range from 5° C. to 70° C., preferably in the range from 10° C. to 50° C. and especially preferably in the range from 15° C. to 40° C.

Steps ii) and iii) can be performed successively or simultaneously. It will be apparent that, when steps ii) and iii) are performed simultaneously, the tube comprising the at least one copolyamide in molten form is obtained only briefly and as an intermediate. Typically, in that case, in the extrusion in step ii), the at least one copolyamide in molten form is extruded directly as a tube into the water bath in step iii) and cooled therein and the at least one copolyamide solidifies to obtain the first tubular film.

It is additionally possible that the tube comprising the at least one copolyamide is guided through a first roll system during the cooling in step iii). This extends the length of the tube.

The present invention therefore also provides a process in which the tube comprising the at least one copolyamide is guided through a first roll system during the cooling in step iii) to extend the length of the tube.

The stretching of the tube aligns the polymer chains of the at least one copolyamide, and can increase the crystallinity of the at least one copolyamide. This process is known to those skilled in the art.

It is additionally possible that the polymer chains of any at least one further polymer (FP) present in the tube are also aligned in the stretching operation. This can also increase the crystallinity of the at least one further polymer (FP).

If the length of the tube is extended, this means that the tube is stretched in extrusion direction. The polymer chains of the at least one copolyamide and of any at least one further polymer (FP) are aligned parallel to the stretching direction.

Step iv)

In step iv), the first tubular film obtained in step iii) is heated to a second temperature (T₂) to obtain a heated first tubular film comprising the at least one copolyamide.

The first tubular film can be heated by any methods known to those skilled in the art, for example by means of infrared sources or a heating ring around the tube.

The second temperature (T₂) to which the first tubular film is heated is preferably above the glass transition temperature (T_{G(C)}) of the at least one copolyamide. It is additionally preferable that the second temperature (T₂) is below the melting temperature (T_{M(C)}) of the at least one copolyamide.

The present invention therefore also provides a process in which the at least one copolyamide has a glass transition temperature (T_{G(C)}) and a melting temperature (T_{M(C)}), and the second temperature (T₂) in step iv) is above the glass transition temperature (T_{G(C)}) and below the melting temperature (T_{M(C)}) of the at least one copolyamide.

For example, the second temperature (T₂) in step iv) is in the range from 50 to 200° C., preferably in the range from 60 to 190° C. and especially preferably in the range from 70 to 180° C.

The present invention therefore also provides a process in which, in step iv), the first tubular film obtained in step iii) is heated to a second temperature (T₂) in the range from 50 to 200° C.

It will be apparent that the second temperature (T₂) to which the first tubular film is heated in step iv) is above the first temperature (T₁) to which the tube is cooled in step iii).

Step v)

In step v), air is blown into the heated first tubular film obtained in step iv) to extend the width of the heated first tubular film, and cooling the heated first tubular film to a third temperature (T₃) to obtain the polymer film (P) comprising the at least one copolyamide.

In the context of the present invention, “air” is understood to mean the gas mixture from the Earth's atmosphere.

In a further embodiment of the present invention, in step v), at least one gas selected from the group consisting of nitrogen, argon and carbon dioxide is blown into the heated first tubular film obtained in step iv).

Air can be blown into the heated first tubular film obtained in step iv) by any methods known to those skilled in the art.

This extends the width of the heated first tubular film. This means that it is stretched at right angles to extrusion direction.

During step v), the heated first tubular film can additionally be guided through a second roll system, which additionally extends the length of the heated first tubular film.

The present invention therefore also provides a process in which the heated first tubular film comprising the at least one copolyamide is guided through a second roll system during the blowing-in of air in step v) to extend the length of the heated first tubular film.

When the heated first tubular film is guided through a second roll system during step v) and/or the tube is guided through a first roll system during the cooling in step iii), the polymer film (P) obtained in step v) is a polymer film (P) that has been stretched both in extrusion direction and at right angles thereto. In that case, it is a biaxially oriented polymer film (P).

“Biaxially oriented” means that the polymer chains are aligned essentially in two different directions, preferably at right angles to one another.

In step v), the first tubular film cools down to a third temperature (T₃). The cooling to the third temperature (T₃) can be effected solely via the blowing of air into the heated first tubular film. In addition, it is possible that the heated first tubular film is additionally cooled during step v).

The third temperature (T₃) to which the heated first tubular film is cooled is preferably below the glass transition temperature (T_{G(C)}) of the at least one copolyamide.

For example, the third temperature (T₃) is in the range from 5 to 50° C., preferably in the range from 10 to 45° C. and especially preferably in the range from 15 to 40° C.

It will be apparent that the third temperature (T₃) to which the heated first tubular film is cooled in step v) is below the second temperature (T₂) to which the first tubular film is heated in step iv).

Preferably in accordance with the invention, the following steps are conducted after step v):
vi) guiding the polymer film (P) obtained in step v) through at least one third roll,
vii) heating the polymer film (P) obtained in step v) to a fourth temperature (T₄) above the glass transition temperature (T_{G(C)}) of the at least one copolyamide to obtain a heated polymer film (P),
viii) guiding the heated polymer film (P) obtained in step vii) through at least one fourth roll, where the heated polymer film (P), between step vii) and step viii), during step viii) and/or after step viii), is cooled to a fifth temperature (T₅) below the glass transition temperature (T_{G(C)}) of the at least one copolyamide.

The present invention therefore also provides a process in which the following steps are conducted after step v):
vi) guiding the polymer film (P) obtained in step v) through at least one third roll,
vii) heating the polymer film (P) obtained in step v) to a fourth temperature (T₄) above the glass transition temperature (T_{G(C)}) of the at least one copolyamide to obtain a heated polymer film (P),
viii) guiding the heated polymer film (P) obtained in step vii) through at least one fourth roll to obtain the polymer film (P),

where the heated polymer film (P), between step vii) and step viii), during step viii) and/or after step viii), is cooled to a fifth temperature (T₅) below the glass transition temperature (T_{G(C)}) of the at least one copolyamide.

Steps vi) to viii) that are optionally conducted after step v) are also referred to as “annealing”.

In step vi), the polymer film (P) is guided through at least one third roll.

In the context of the present invention, “at least one third roll” means either exactly one third roll or a third roll system.

Preferably, the polymer film (P) in step vi) is guided through a third roll system.

Suitable third rolls are known to those skilled in the art. Suitable third roll systems are likewise known to those skilled in the art.

The at least one third roll typically has a first speed of rotation.

In one embodiment of the present invention, steps v) and vi) are performed simultaneously. In that case, in step v), the heated first tubular film is additionally guided through a second roll system and the second roll system is identical to the at least one third roll through which the polymer film (P) is guided in step vi).

The present invention therefore also provides a process in which the heated first tubular film comprising the at least one copolyamide is guided through a second roll system during the blowing-in of air in step v) to extend the length of the heated first tubular film, and the following steps are conducted after step v):
vii) heating the polymer film (P) obtained in step v) to a fourth temperature (T₄) above the glass transition temperature (T_{G(C)}) of the at least one copolyamide to obtain a heated polymer film (P),
viii) guiding the heated polymer film (P) obtained in step vii) through at least one fourth roll to obtain the polymer film (P),

where the heated polymer film (P), between step vii) and step viii), during step viii) and/or after step viii), is cooled to a fifth temperature (T₅) below the glass transition temperature (T_{G(C)}) of the at least one copolyamide.

In step vii), the polymer film (P) is heated to a fourth temperature (T₄).

The heating is preferably effected after the polymer film (P) has been guided through the at least one third roll in step vi). When the heated first tubular film is guided through a second roll system during step v) and the at least one third roll is identical to the second roll system, the heating is preferably conducted after the guiding through the second roll system.

The heating of the polymer film (P) obtained to the fourth temperature (T₄) in step vii) can be effected by any methods known to those skilled in the art.

According to the invention, the fourth temperature (T₄) is above the glass transition temperature (T_{G(C)}) of the at least one copolyamide. It is additionally preferable that the fourth temperature (T₄) is below the melting temperature (T_{M(C)}) of the at least one copolyamide.

The present invention therefore also provides a process in which the fourth temperature (T₄) is below the melting temperature (T_{M(C)}) of the at least one copolyamide.

It will be apparent that the fourth temperature (T₄) to which the polymer film (P) is optionally heated in step vii) is above the third temperature (T₃) to which the heated first tubular film is cooled in step v).

In step viii), the heated polymer film (P) is guided through at least one fourth roll.

In the context of the present invention, “at least one fourth roll” means either exactly one fourth roll or a fourth roll system.

The at least one fourth roll typically has a second speed of rotation.

Preferably in accordance with the invention, the first speed of rotation of the at least one third roll is higher than the second speed of rotation of the at least one fourth roll.

Between step vii) and step viii), during step viii) and/or after step viii), the heated polymer film (P) is cooled to a fifth temperature (T₅). The fifth temperature (T₅) is below the glass transition temperature (T_{G(C)}) of the at least one copolyamide.

It will be apparent that the fifth temperature (T₅) is below the fourth temperature (T₄).

The cooling to the fifth temperature (T₅) can be effected by any methods known to those skilled in the art, for example by cooling by means of air.

By conducting steps vi) to viii), a polymer film (P) having particularly low preshrinkage is obtained. The polymer film (P) thus shrinks only to a minor degree, if at all, between production thereof and use thereof, for example as packing film. The same is true when the heated first tubular film is guided through a second roll system in step v) and then steps vi) to viii) are conducted.

Polymer film (P)

The polymer film (P) produced in accordance with the invention comprises the at least one copolyamide.

The polymer film (P) has a thickness, for example, in the range from 0.1 μm to 1 mm, preferably a thickness in the range from 5 to 500 μm and especially preferably in the range from 20 to 100 μm.

The present invention therefore also provides a process in which the polymer film (P) has a thickness in the range from 0.1 μm to <1 mm.

The polymer film (P) may comprise at least one further polymer (FP) in addition to the at least one copolyamide.

In the context of the present invention, “at least one further polymer (FP)” means either exactly one further polymer (FP) or a mixture of two or more further polymers (FP).

Polymers suitable as the at least one further polymer (FP) are all polymers known to those skilled in the art. It will be apparent that the at least one further polymer (FP) is different than the at least one copolyamide.

Preferably, the at least one further polymer (FP) is selected from the group consisting of polyolefins, poly(ethylene-vinyl alcohols), poly(ethylene-vinyl acetates), polyethylene terephthalates, polyvinylidene chlorides, maleic anhydride-grafted polyolefins, polyesters and ionomers.

More preferably, the at least one further polymer (FP) is selected from the group consisting of polyolefins, poly(ethylene-vinyl alcohols), poly(ethylene-vinyl acetates), polyethylene terephthalates, polyvinylidene chlorides and maleic anhydride-grafted polyolefins.

Most preferably, the at least one further polymer (FP) is selected from the group consisting of polyolefins, maleic anhydride-grafted polyolefins and ethylene-vinyl alcohols.

If the at least one further polymer (FP) is selected from the group consisting of polyolefins, it is preferable that, in addition, maleic anhydride-grafted polyolefins are used as at least one further polymer (FP). It is possible here that the at least one further polymer (FP) used is a mixture of polyolefins and maleic anhydride-grafted polyolefins. It is likewise possible that, when the polymer film (P) is a multilayer film described further down, the polymer film (P) comprises at least one first further layer of at least one further polymer (FP), where the at least one further polymer (FP) of the first further layer is selected from the group consisting of maleic anhydride-grafted polyolefins and the polymer film (P) comprises at least one second further layer of at least one further polymer (FP), where the at least one further polymer (FP) of the second further layer is selected from the group consisting of polyolefins. The polymer film (P) in that case preferably comprises the first further layer between the first layer comprising the at least one copolyamide and the second further layer.

Polyolefins as such are known to those skilled in the art. Preferred polyolefins are polypropylene (PP), low-density polyethylene (LDPE), linear low-density polyethylene (LLDPE) and very low-density polyethylene (VLDPE).

Linear low-density polyethylene (LLDPE) is a copolymer of ethylene and at least one C₄-C₃-α-olefin. Linear low-density polyethylene (LLDPE) features long polymer chains with short side chains. The length of the side chains in linear low-density polyethylene (LLDPE) is typically shorter than in low-density polyethylene (LDPE) and in medium-density polyethylene (MDPE). The melting point of linear low-density polyethylene (LLDPE) is preferably in the range from 110 to 130° C.; its density is in the range from 0.91 to 0.93 g/cm³.

Very low-density polyethylenes (VLDPE) are copolymers of ethylene and at least one C₄-C₈-α-olefin. They typically have a melting point in the range from 110 to 130° C. and a density in the range from 0.86 to <0.91 g/cm³. The proportion of C₄-C₈-α-olefins in VLDPE is generally higher than in LLDPE.

In the contex of the present invention, “C₄-C₃-α-olefin” is understood to mean linear and branched, preferably linear, alkylenes having 4 to 8 carbon atoms that are unsaturated in the a position, i.e. have a C—C double bond in the a position. Examples of these are 1-butene, 1-pentene, 1-hexene, 1-heptene and 1-octene. 1-Butene, 1-Hexene and 1-octene are preferred.

Preferred poly(ethylene-vinyl acetates) are copolymers of ethylene with vinyl acetate. For example, they are prepared using in the range from 82% to 99.9% by weight of ethylene and in the range from 0.1% to 18% by weight of vinyl acetate, preferably in the range from 88% to 99.9% by weight of ethylene and in the range from 0.1% to 12% by weight of vinyl acetate.

Preferred poly(ethylene-vinyl alcohols) are obtainable by complete or partial hydrolysis of the above-described poly(ethylene-vinyl acetates). For example, the poly(ethylene-vinyl alcohols) comprise in the range from 50 to 75 mol % of ethylene and in the range from 25 to 50 mol % of vinyl alcohol, based on the total molar amount of the poly(ethylene-vinyl alcohols).

The polymer film (P) may comprise the at least one further polymer (FP) as a blend (mixture) with the at least one copolyamide.

Furthermore, it is possible and preferable in accordance with the invention that the polymer film (P) comprises at least one first layer comprising the at least one copolyamide, and the polymer film (P) comprises at least one further layer comprising the at least one further polymer (FP).

In this embodiment, it is preferable that the at least one first layer comprising the at least one copolyamide does not comprise any further polymer (FP).

In the context of the present invention, “at least one first layer” means either exactly one first layer or two or more first layers.

As already described above, the number of first layers is found from the number of first extruders that are used in step i) of the process of the invention.

In the context of the present invention, “at least one further layer” means either exactly one further layer or two or more further layers. Two or more further layers are preferred.

As detailed hereinafter, the number of further layers is found from the number of further extruders that are used in one embodiment of the process of the invention.

It is thus preferable that the polymer film (P) comprises at least one first layer comprising the at least one copolyamide, and the polymer film (P) also comprises at least one further layer, where the at least one further layer comprises at least one further polymer (FP) selected from the group consisting of polyolefins, poly(ethylene-vinyl alcohols), poly(ethylene-vinyl acetates), polyethylene terephthalates, polyvinylidene chlorides and maleic anhydride-grafted polyolefins.

The present invention thus also provides a process in which the polymer film (P) comprises at least one first layer comprising the at least one copolyamide, and the polymer film (P) comprises at least one further layer, where the at least one further layer comprises at least one further polymer (FP) selected from the group consisting of polyolefins, poly(ethylene-vinyl alcohols), poly(ethylene-vinyl acetates), polyethylene terephthalates, polyvinylidene chlorides and maleic anhydride-grafted polyolefins.

If the polymer film (P), apart from the at least one first layer, does not comprise any further layer, the polymer film (P) is also referred to as a “monofilm”. If the polymer film (P) is a monofilm, it may comprise exactly one first layer and no further layer; it is likewise possible that it comprises two or more first layers and no further layer. If the polymer film (P) comprises two or more first layers and is a monofilm, the two or more first layers all have the same composition.

If the polymer film (P) comprises at least one first layer comprising the at least one copolyamide, and at least one further layer comprising the at least one further polymer (FP), the polymer film (P) is also referred to as a multilayer film.

For example, the polymer film (P) in that case comprises 1 to 11 first layers comprising the at least one copolyamide, and 1 to 13 further layers comprising the at least one further polymer (FP). Preferably, the polymer film (P) comprises 1 to 5 first layers comprising the at least one copolyamide, and 1 to 11 further layers comprising the at least one further polymer (FP). Especially preferably, the polymer film (P) comprises 1 to 3 first layers comprising the at least one copolyamide, and 1 to 7 further layers comprising the at least one further polymer (FP).

In a preferred embodiment of the present invention, the at least one first layer consists of the at least one copolyamide. It is likewise preferable that the at least one further layer consists of the at least one further polymer (FP).

In the context of the present invention, the term “polymer film (P)” thus comprises both monofilms and multilayer films.

The present invention therefore also provides a process wherein the polymer film (P) is a monofilm or a multilayer film.

As described above, the polymer film (P) typically has a thickness in the range from 0.1 μm to 1 mm, preferably in the range from 5 to 500 μm and especially preferably in the range from 10 to 100 μm.

If the polymer film (P) is a monofilm and comprises exactly one first layer, the first layer has the same thickness as the polymer film (P), i.e., for example, in the range from 0.1 μm to 1 mm, preferably in the range from 5 to 500 μm and especially preferably in the range from 10 to 100 μm. If the polymer film (P) is a monofilm and comprises two or more first layers, the thickness of every first layer is typically less than the thickness of the polymer film (P). The sum total of the thicknesses of the individual first layers in that case generally corresponds to the thickness of the polymer film (P). For example, the at least one first layer comprising the at least one copolyamide in that case has a thickness in the range from 0.1 to 100 μm, preferably in the range from 0.5 to 50 μm and especially preferably in the range from 0.5 to 15 μm.

If the polymer film (P) is a multilayer film, the thickness of the individual layers of the polymer film (P), i.e. the thickness of the at least one first layer comprising the at least one copolyamide, and the thickness of the at least one further layer comprising the at least one further polymer (FP), is typically less than the thickness of the polymer film (P). The sum total of the thicknesses of the individual layers in that case generally corresponds to the thickness of the polymer film (P).

For example, the at least one first layer comprising the at least one copolyamide in that case has a thickness in the range from 0.1 to 100 μm, preferably in the range from 0.5 to 50 μm and especially preferably in the range from 0.5 to 15 μm.

The at least one further layer comprising the at least one further polymer (FP) in that case has a thickness, for example, in the range from 0.1 to 100 μm, preferably in the range from 0.5 to 50 μm and especially preferably in the range from 0.5 to 15 μm.

The polymer film (P) may comprise at least one adhesion promoter. This embodiment is preferred when the polymer film (P) is a multilayer film.

In the context of the present invention, “at least one adhesion promoter” means either exactly one adhesion promoter or a mixture of two or more adhesion promoters.

If the polymer film (P) is a multilayer film, the at least one adhesion promoter may be present together with the at least one copolyamide in the at least one first layer. It is likewise possible that the at least one adhesion promoter is present together with the at least one further polymer (FP) in the at least one further layer. Furthermore, it is possible that the at least one adhesion promoter is present as at least one additional layer in the polymer film (P). This embodiment is preferred.

When the at least one adhesion promoter is present as at least one additional layer in the polymer film (P), the at least one adhesion promoter, in the process of the invention, is typically provided in an additional extruder and then likewise extruded therefrom through the ring die in step ii).

When the at least one adhesion promoter is present as at least one additional layer in the polymer film (P), this at least one additional layer is preferably arranged between the at least one further layer comprising the at least one further polymer (FP) and the at least one first layer comprising the at least one copolyamide. The at least one layer of the adhesion promoter has a thickness, for example, of 0.1 to 100 μm, preferably in the range from 0.5 to 50 μm and especially preferably in the range from 0.5 to 15 μm.

Suitable adhesion promoters are known as such to the person skilled in the art. Preferred adhesion promoters are copolymers of ethylene with maleic anhydride or a copolymer of ethylene with vinyl acetate. Preference is given to a copolymer of linear low-density polyethylene (LLDPE) and maleic anhydride or a copolymer of ethylene and vinyl acetate, the copolymer being prepared using >18% by weight of vinyl acetate and <82% by weight of ethylene. These copolymers are commercially available, for example under the Bynel 4105 trade name from DuPont or Escorene FL00119 trade name from Exxon.

Copolymers of ethylene with maleic anhydride that are used as adhesion promoters are preferably maleic anhydride-grafted polymers or copolymers of ethylene.

The polymer film (P) may also comprise additives when they have been provided in the first extruder together with the at least one copolyamide and/or in the further extruder together with the at least one further polymer (FP). The details and preferences described above are correspondingly applicable to the additives.

The additives may be present either in the at least one first layer or in the at least one further layer. They may be present in just one of these layers; it is likewise possible that they are present in each of these layers.

It will be clear to the person skilled in the art that, when the additives are provided together with at least one copolyamide in the first extruder, the additives are present in the first layer. If the additives are provided together with the at least one further polymer (FP) in the further extruder, the additives are present in the further layer.

The present invention therefore also provides a polymer film obtainable by the process of the invention.

If the polymer film (P) is to comprise at least one further polymer (FP), the process of the invention preferably additionally comprises a step i1), providing at least one further polymer (FP) in molten form in a further extruder, where step i1) is conducted before step ii).

The present invention therefore also provides a process in which the step of

i1) providing at least one further polymer (FP) in molten form in a further extruder, where step i1) is conducted before step ii).

More preferably, step i1) is conducted simultaneously with step i).

It will be apparent that, when step i1) is conducted, the tube obtained in step ii) additionally comprises the further polymer (FP) in molten form. In that case, the first tubular film obtained in step iii) and the heated first tubular film obtained in step iv) likewise additionally comprise the at least one further polymer.

Preferably, the process for producing the polymer film (P) in that case comprises the steps of

i) providing at least one copolyamide prepared by polymerizing the following components:
(A) 15% to 84% by weight of at least one lactam,
(B) 16% to 85% by weight of a monomer mixture (M) comprising the following components:
   (B1) at least one C₃₂-C₄₀ dimer acid and
   (B2) at least one C₄-C₁₂ diamine,

where the percentages by weight of components (A) and (B) are each based on the sum total of the percentages by weight of components (A) and (B), in molten form in an extruder,
i1) providing at least one further polymer (FP) in molten form in a further extruder,
ii) extruding the at least one copolyamide provided in step i) in molten form from the first extruder through a ring die and extruding the at least one further polymer (FP) provided in step i1) in molten form from the further extruder through the ring die to obtain a tube comprising the at least one copolyamide and the at least one further polymer (FP), each in molten form,
iii) cooling the tube obtained in step ii) which comprises the at least one copolyamide and the at least one further polymer (FP), each in molten form, in a water bath to a first temperature (T₁), solidifying the at least one copolyamide and the at least one further polymer (FP) to obtain a first tubular film comprising the at least one copolyamide and the at least one further polymer (FP),
iv) heating the first tubular film obtained in step iii) to a second temperature (T₂) to obtain a heated first tubular film comprising the at least one copolyamide and the at least one further polymer (FP),
v) blowing air into the heated first tubular film obtained in step iv) to extend the width of the heated first tubular film, and cooling the heated first tubular film to a third temperature (T₃) to obtain the polymer film (P) comprising the at least one copolyamide and the at least one further polymer (FP).

The present invention therefore also provides a process for producing a polymer film (P) comprising the steps of

i) providing at least one copolyamide prepared by polymerizing the following components:
(A) 15% to 84% by weight of at least one lactam,
(B) 16% to 85% by weight of a monomer mixture (M) comprising the following components:
   (B1) at least one C₃₂-C₄₀ dimer acid and
   (B2) at least one C₄-C₁₂ diamine,

where the percentages by weight of components (A) and (B) are each based on the sum total of the percentages by weight of components (A) and (B), in molten form in an extruder,
i1) providing at least one further polymer (FP) in molten form in a further extruder,
ii) extruding the at least one copolyamide provided in step i) in molten form from the first extruder through a ring die and extruding the at least one further polymer (FP) provided in step i1) in molten form from the further extruder through the ring die to obtain a tube comprising the at least one copolyamide and the at least one further polymer (FP), each in molten form,
iii) cooling the tube obtained in step ii) which comprises the at least one copolyamide and the at least one further polymer (FP), each in molten form, in a water bath to a first temperature (T₁), solidifying the at least one copolyamide and the at least one further polymer (FP) to obtain a first tubular film comprising the at least one copolyamide and the at least one further polymer (FP),
iv) heating the first tubular film obtained in step iii) to a second temperature (T₂) to obtain a heated first tubular film comprising the at least one copolyamide and the at least one further polymer (FP),
v) blowing air into the heated first tubular film obtained in step iv) to extend the width of the heated first tubular film, and cooling the heated first tubular film to a third temperature (T₃) to obtain the polymer film (P) comprising the at least one copolyamide and the at least one further polymer (FP).

In the context of the present invention, “a further extruder” means either exactly one further extruder or two or more further extruders. Preference is given to two or more further extruders.

Preferably, as many further extruders are used as the number of further layers comprising the at least one further polymer (FP) that are to be present in the polymer film (P). For example, 1 to 13 further extruders are used, preferably 1 to 11 further extruders and especially preferably 1 to 7 further extruders.

If the polymer film is to comprise, for example, exactly one further layer comprising the at least one further polymer (FP), exactly one further extruder is used. If the polymer film (P) is to comprise exactly two further layers comprising the at least one further polymer (FP), exactly two further extruders are used. If the polymer film (P) is to comprise exactly five further layers comprising the at least one further polymer (FP), exactly five further extruders are used.

The details and preferences described above for the first extruder are correspondingly applicable to the further extruder.

The details and preferences described above for any at least one further polymer (FP) present in the polymer film (P) are correspondingly applicable to the at least one further polymer (FP).

According to the invention, the at least one further polymer (FP) in step i1) is provided in molten form. “In molten form” means that the at least one further polymer (FP) is provided at a temperature above the melting temperature (T_{M(FP)}) of the at least one further polymer (FP). “In molten form” thus means that the at least one further polymer (FP) is at a temperature above the melting temperature (T_{M(FP)}) of the at least one further polymer (FP). If the at least one further polymer (FP) is in molten form, the at least one further polymer (FP) is free-flowing.

“Free-flowing” means that the at least one further polymer (FP) can be conveyed in the further extruder and that the at least one further polymer (FP) can be extruded from the further extruder.

For example, the at least one further polymer (FP) is provided in step i1) at a temperature in the range from 120 to 350° C., preferably in the range from 130 to 300° C. and especially preferably in the range from 140 to 250° C., in each case assuming that the temperature at which the at least one further polymer (FP) is provided is above the melting temperature (T_{M(FP)}) of the at least one further polymer (FP).

The at least one further polymer (FP) may be provided in molten form in the further extruder by any methods known to those skilled in the art. For example, the at least one further polymer (FP) can be supplied to the further extruder in molten or solid form. If the at least one further polymer (FP) is supplied to the further extruder in solid form, it can be supplied to the further extruder, for example, in the form of pellets and/or of powder. The at least one further polymer (FP) is then melted in the further extruder and thus provided in molten form in the further extruder.

It is additionally possible that, in step i1), additives are provided in the further extruder together with the at least one further polymer (FP) in molten form. The additives are typically compounded (mixed) with the at least one further polymer (FP) in molten form in the further extruder. Processes for this purpose are known to those skilled in the art.

The details and preferences described above for the additives that are optionally provided together with the at least one copolyamide in molten form in the first extruder are correspondingly applicable to the additives that are optionally provided together with the further polymer (FP) in molten form in the further extruder.

The additives that are optionally provided together with the further polymer (FP) in molten form in the further extruder and the additives that are optionally provided together with the at least one copolyamide in molten form in the first extruder may be the same or different. Preferably, the additives that are optionally provided together with the further polymer (FP) in molten form in the further extruder and the additives that are optionally provided together with the at least one copolyamide in molten form in the first extruder are different.

The details and preferences described above for steps i), ii), iii), iv) and v) for production of the polymer film (P) comprising the at least one copolyamide are correspondingly applicable to steps i), ii), iii), iv) and v) for production of the polymer film (P) comprising the at least one copolyamide and the at least one further polymer (FP).

The tube obtained in step ii), comprising the at least one copolyamide and the at least one further polymer (FP), each in molten form, comprises the at least one copolyamide in at least one first layer and the at least one further polymer (FP) in at least one further layer. Typically, the tube obtained in step ii) comprises as many first layers comprising the at least one copolyamide in molten form as the number of first extruders that have been used in step i) and as many further layers comprising the at least one further polymer (FP) in molten form as the number of further extruders that have been used in step i1).

The first temperature (T₁) in step iii) when step i1) is performed is preferably also below the melting temperature (T_{M(FP)}) of the at least one further polymer (FP).

The second temperature (T₂) in step iv) when step i1) is conducted is preferably also above the glass transition temperature (T_{G(FP)}) of the at least one further polymer (FP) and especially preferably also below the melting temperature (T_{M(FP)}) of the at least one further polymer (FP).

The third temperature (T₃) in step v) when step i1) is performed is preferably below the melting temperature (T_{M(FP)}) of the at least one further polymer (FP).

It will be apparent that, when step i1) is conducted, the polymer film (P) obtained in step v) is a multilayer film.

Packing of Foods

The polymer film (P) produced in accordance with the invention can be used in a process for packing foods.

The present invention therefore also provides for the use of the polymer film (P) of the invention for packing foods.

For example, the process for packing foods comprises the following steps:
a) providing a food ensheathed by at least one polymer film (P) of the invention, where the at least one polymer film (P) has a provision temperature (T_{B}),
b) heating the at least one polymer film (P) to a shrink temperature (T_{S}), which results in shrinkage of the at least one polymer film (P) to obtain the food ensheathed by the at least one shrunk polymer film (P).

The present invention therefore also provides a process for packing foods comprising the steps of
a) providing a food ensheathed by at least one polymer film (P) according to claim 11, where the at least one polymer film (P) has a provision temperature (T_{B}),
b) heating the at least one polymer film (P) to a shrink temperature (T_{S}), which results in shrinkage of the at least one polymer film (P) to obtain the food ensheathed by the at least one shrunk polymer film (P).

In step a), the food ensheathed by at least one polymer film (P) is provided.

The details and preferences described above for the polymer film (P) are correspondingly applicable to the at least one polymer film (P).

Suitable foods are all known foods. Cheese products, meat products and sausage products are especially suitable.

In the context of the present invention, “ensheathed by the at least one polymer film (P)” means that at least 20%, preferably at least 50%, especially preferably at least 80% and most preferably 100% of the surface of the food is covered by the at least one polymer film (P). “Covered” means that the at least one polymer film (P) and the surface of the food may be in direct contact with one another. It is likewise possible that air is present at least to some degree between the surface of the food and the at least one polymer film (P).

The at least one polymer film (P) has a provision temperature (T_{B}) in step a).

The provision temperature (T_{B}) is preferably below the glass transition temperature (T_{G(C)}) of the at least one copolyamide present in the at least one polymer film (P).

For example, the polymer film (P) has a provision temperature (T_{B}) in the range from 5 to 50° C., preferably in the range from 10 to 45° C. and especially preferably in the range from 15 to 40° C.

The present invention therefore also provides a process for packing foods, wherein the provision temperature (T_{B}) is below the glass transition temperature (T_{G(C)}) of the at least one copolyamide present in the at least one polymer film (P).

The present invention further provides a process for packing foods, wherein the provision temperature (T_{B}) is in the range from 5 to 50° C.

In step b), the at least one polymer film (P) is heated to a shrink temperature (T_{S}). The shrink temperature (T_{S}) is therefore above the provision temperature (T_{B}) of the polymer film (P).

Preferably, the shrink temperature is above the glass transition temperature (T_{G(C)}) of the at least one copolyamide present in the at least one polymer film (P). For example, the shrink temperature (T₃) is in the range from 50 to 200° C., preferably in the range from 60 to 180° C. and especially preferably in the range from 70 to 120° C.

The present invention therefore also provides a process in which the shrink temperature (T_{S}) in step b) is above the glass transition temperature (T_{G(C)}) of the at least one copolyamide present in the at least one polymer film (P).

The present invention further provides a process for packing foods, in which the shrink temperature (T_{S}) in step b) is in the range from 50 to 200° C.

The at least one polymer film (P) can be heated to the shrink temperature (T₃) by any methods known to those skilled in the art. For example, it can be heated to the shrink temperature (T₃) by steam or hot air. In step b), the at least one polymer film (P) shrinks. The at least one polymer film (P) may already shrink while it is being heated to the shrink temperature (T₃). It is likewise possible that the at least one polymer film does not shrink until its temperature is at the shrink temperature (T₃).

In the context of the present invention, “shrinking” means that the volume of the at least one polymer film (P) decreases relative to the volume of the at least one polymer film (P) at the provision temperature (T_{B}). For example, the volume of the at least one polymer film (P) decreases by 10% to 80%, preferably by 20% to 70% and especially preferably by 30% to 60%, based in each case on the volume of the at least one polymer film (P) at the provision temperature (T_{B}).

The at least one shrunk polymer film (P) may entirely or partly ensheath the food in step b).

For example, the at least one shrunk polymer film (P) covers at least 20%, preferably at least 50%, especially preferably at least 80% and most preferably 100% of the surface of the food. “Covered” means that the at least one shrunk polymer film (P) and the surface of the food may be in direct contact with one another. It is likewise possible that air is present at least to some degree between the surface of the food and the at least one shrunk polymer film (P).

The at least one shrunk polymer film (P) that ensheaths the food has a particularly high oxygen barrier and therefore gives particularly good protection of the food from the ingress of oxygen. This good oxygen impermeability is maintained even at high air humidities and high temperatures, for example above 25° C.

1. A process for producing a polymer film (P) the process comprising:
i) polymerizing the following components to obtain at least one copolyamide:
(A) 15% to 84% by weight of at least one lactam,
(B) 16% to 85% by weight of a monomer mixture (M) comprising the following components:
(B1) at least one C₃₂-C₄₀ dimer acid and
(B2) at least one C₄-C₁₂ diamine,
where the percentages by weight of components (A) and (B) are each based on the sum total of the percentages by weight of components (A) and (B), in molten form in a first extruder;
ii) extruding the at least one copolyamide i) in molten form from a first extruder through a ring die to obtain a tube comprising the at least one copolyamide in molten form;
iii) cooling the tube ii) which comprises the at least one copolyamide in molten form in a water bath to a first temperature (T₁), and solidifying the at least one copolyamide to obtain a first tubular film comprising the at least one copolyamide;
iv) heating the first tubular film iii) to a second temperature (T₂) to obtain a heated first tubular film comprising the at least one copolyamide; and
v) blowing air into the heated first tubular film iv) to extend the width of the heated first tubular film, and cooling the heated first tubular film to a third temperature (T₃) to obtain the polymer film (P) comprising the at least one copolyamide.

2. The process according to claim 1, wherein lactam (A) is selected from the group consisting of 3-aminopropanolactam, 4-amino butanolactam, 5-aminopentanolactam, 6-aminohexanolactam, 7-aminoheptanolactam, 8-aminooctanolactam, 9-aminononanolactam, 10-aminodecanolactam, 11-amino undecanolactam and 12-aminododecanolactam.

3. The process according to claim 1, wherein the C₄-C₁₂ diamine (B2) is selected from the group consisting of tetramethylenediamine, pentamethylenediamine, hexamethylenediamine, decamethylenediamine and dodecamethylenediamine.

4. The process according to claim 1, wherein the tube ii) has a thickness in the range from 10 μm to 1 mm.

5. The process according to claim 1, wherein the first temperature (T₁) in step iii) is in the range from 5 to 50° C.

6. The process according to claim 1, wherein:
the at least one copolyamide has a glass transition temperature (T_{G(C)}) and a melting temperature (T_{M(C)}); and
the second temperature (T₂) in step iv) is above the glass transition temperature (T_{G(C)}) and below the melting temperature (T_{M(C)}) of the at least one copolyamide.

7. The process according to claim 1, wherein the tube comprising the at least one copolyamide is guided through a first roll system during the cooling in step iii) to extend the length of the tube.

8. The process according to claim 1, wherein the heated first tubular film comprising the at least one copolyamide is guided through a second roll system during the blowing-in of air in step v) to extend the length of the heated first tubular film.

9. The process according to claim 1, wherein the polymer film (P) has a thickness in the range from 0.1 μm to <1 mm.

10. The process according to claim 1, further comprising, after step v):
vi) guiding the polymer film (P) obtained in step v) through at least one third roll;
vii) heating the polymer film (P) obtained in step v) to a fourth temperature (T₄) above the glass transition temperature (T_{G(C)}) of the at least one copolyamide to obtain a heated polymer film (P); and
viii) guiding the heated polymer film (P) obtained in step vii) through at least one fourth roll to obtain the polymer film (P),
where the heated polymer film (P), between step vii) and step viii), during step viii) and/or after step viii), is cooled to a fifth temperature (T₅) below the glass transition temperature (T_{G(C)}) of the at least one copolyamide.

11. A polymer film (P) obtained by the process of claim 1.

12. A process for packing foods, the process comprising:
a) providing a food ensheathed by at least one polymer film (P) according to claim 11, where the at least one polymer film (P) has a provision temperature (T_{B}); and
b) heating the at least one polymer film (P) to a shrink temperature (T_{S}), which results in shrinkage of the at least one polymer film (P) to obtain the food ensheathed by the at least one shrunk polymer film (P).

13. The process according to claim 12, wherein the shrink temperature (T_{S}) in step b) is in the range from 50 to 200° C.

14. The process according to claim 12, wherein the shrink temperature (T_{S}) in step b) is above the glass transition temperature (T_{G(C)}) of the at least one copolyamide present in the at least one polymer film (P).
